(19) United States
(12) Patent Application Publication
(10) Pub. No.: US 2020/0361738 A1
(43) Pub. Date: Nov. 19, 2020

(54) MEDIA DUPLEXING

(71) Applicant: Hewlett-Packard Development Company, L.P., Spring, TX (US)

(72) Inventors: Xiaoxi Huang, Singapore (SG); Lian Chye Simon Tan, Singapore (SG)

(21) Appl. No.: 16/958,203

(22) PCT Filed: Jan. 25, 2018
(86) PCT No.: PCT/US2018/015193

§ 371 Date: Jun. 26, 2020

(51) Int. Cl. B65H 29/60; B65H 85/00; B41J 13/00

(52) U.S. Cl. CPC B65H 29/60; B65H 85/00; B65H 2801/06; B65H 2404/63; B41J 13/0045

(57) ABSTRACT

Examples of imaging devices are described, in an example, an imaging device may include a first media roller assembly and a media duplexing apparatus. The media duplexing apparatus may include a second media roller assembly and a media diverter. The media diverter may be movable to a first position or to a second position to route a medium in the imaging device.

### BACKGROUND

Imaging devices, such as printers may be used to print on media of various sizes. An example of a medium may be a paper, a film, and such. Media may be of different sizes, for example A4, A3, and so on. Imaging devices may be used for single-side printing or for duplex printing of a medium. For single-side printing, the medium may be moved through a path from a media source to a printing unit of the imaging device and subsequently dispensed out from the imaging device. For duplex printing, the medium, after printing on one side, may be moved through a path to turn-over the medium before moving the medium again to the printing unit to print on the other side.

### BRIEF DESCRIPTION OF DRAWINGS

The following detailed description references the drawings, wherein:

FIG. 1 illustrates a side view of an imaging device with a media duplexing apparatus, according to an example;

FIG. 2 illustrates a path followed by a medium for printing on a first side, when a media diverter of the media duplexing apparatus is in a first position, according to an example;

FIG. 3 illustrates a path followed by a medium for printing on a second side, when a media diverter of the media duplexing apparatus is in a first position, according to an example;

FIG. 4 illustrates a path followed by a medium for printing on a first side, when a media diverter of the media duplexing apparatus is in a second position, according to an example;

FIG. 5 illustrates a path followed by a medium for printing on a second side, when a media diverter of the media duplexing apparatus is in a second position, according to an example;

FIG. 6 illustrates a side view of an imaging device with a media duplexing apparatus, according to an example;

FIG. 7 illustrates the imaging device of FIG. 6 with the media diverter positioned to route a medium from a second media source towards a printing unit of the imaging device, according to an example;

FIG. 8 illustrates a cross-sectional side view of a media duplexing apparatus, according to an example;

FIG. 9 illustrates a side view of an imaging device with the media duplexing apparatus of FIG. 8, according to an example;

FIG. 10 illustrates a side view of an imaging device with a media duplexing apparatus, according to an example;

FIG. 11 illustrates the imaging device of FIG. 9, according to an example;

FIG. 12 illustrates a side view of the imaging device of FIG. 10 with a biasing element coupled to the media diverter, according to an example; and

FIG. 13 illustrates the imaging device of FIG. 12 with the biasing element in a biased state, according to an example.

### DETAILED DESCRIPTION

Imaging devices that can perform duplex printing of media, i.e., print on both sides of media, may include a media roller assembly. The media roller assembly of the imaging device may be operated to pick a medium, for example a paper, from a media source and move the medium towards a printing unit to print on one side of the medium. The media roller assembly of the imaging device may then be operated to turn-over the one-side printed medium, and move the medium towards the printing unit to print on the other side. The medium may thus follow a certain path within the imaging device for duplex printing.

A medium which is larger in size may utilize a longer path for its turn-over inside an imaging device for the purpose of duplex printing. Since the path followed by the media is fixed, the imaging device generally accommodates a path of a length depending on the largest sized media which can be duplex printed by the imaging device. The imaging device with a longer path for duplex printing of media may be larger in size. Further, a compact imaging device, such as a home or small office printer, generally accommodates a path for duplex printing of media of a threshold size, for example A4 size, or smaller. Such an imaging device may not be able to perform duplex printing of media of a larger size, for example A3. It is noted that the term “threshold size” is used hereinafter to refer to a media size threshold and may refer to a size limit below which a first duplexing path is to be used and above which a second duplexing path is to be used. For example, the “threshold size” for one example imaging device may refer to a largest supported duplexing size (e.g., A4 size in one case) that can be printed by the imaging device without the benefit of a supplemental media duplexing unit.

The present subject matter describes a media duplexing apparatus that can be coupled to an imaging device to scale up the capability of the imaging device to duplex printing of a medium of a larger size. In accordance with an example, the imaging device may include a first media roller assembly. The first media roller assembly may refer to a media roller assembly of the imaging device that may provide a first path for duplex printing of media. The first path may refer to the original path available in the imaging device, when the media duplexing apparatus is not coupled to the imaging device. The media duplexing apparatus, coupled to the imaging device, may provide a second path for duplex printing. The second path may be a path followed by a medium passing through the media duplexing apparatus. The second path may be longer than the first path. In an example, the media duplexing apparatus may include a second media roller assembly and a media diverter. The media diverter may be selectively movable to a first position or to a second position to route a medium over the first path or the second path, depending on the size of the medium, for duplex printing.

In an example, when a medium of a threshold size, for example A4 size, or smaller, is to be duplex printed, the media diverter may be moved to the first position so as to route the medium over the first path through the first media roller assembly towards a printing unit of the imaging device. When a medium of a size larger than the threshold size, for example A3 size, or larger is to be duplex printed, the media diverter may be moved to the second position so as to route the medium over the second path through the second media roller assembly towards the printing unit of imaging device.

The media duplexing apparatus of the present subject matter, when coupled to an imaging device, may allow to scale up the length of the path for duplex printing of a medium of a larger size, without affecting the compactness of the imaging device. The media duplexing apparatus may selectively provide paths of different lengths depending on the size of media to be duplex printed.

The media duplexing apparatus of the present subject matter may be an add-on unit which may be coupled to an imaging device for the purpose of duplex printing of media of a size larger than a threshold size, which the imaging device as such is capable of printing. The media duplexing apparatus may be removed from the imaging device, or may not be coupled to the imaging device at all, when media of the threshold size or a size smaller than the threshold size are to be duplex printed.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

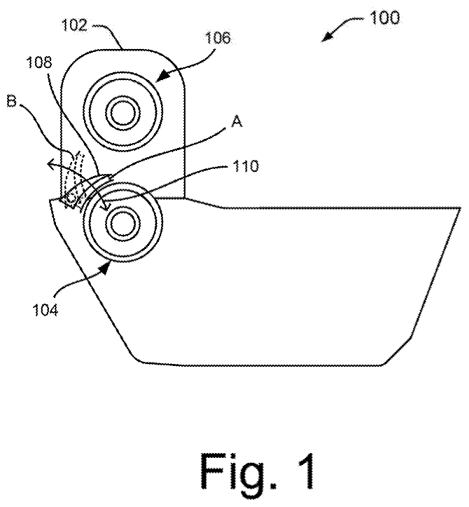

FIG. 1 illustrates a side view of an imaging device 100 with a media duplexing apparatus 102, according to an example. The imaging device 100 may be a printer. The imaging device 100, without the media duplexing apparatus 102, may be capable of duplex printing of media of a threshold size or smaller than the threshold size. In an example, media may be an object, such as paper, on which markings, including text and images, can be printed by the imaging device 100. As noted above, the term “threshold size” as used herein may refer to a specific largest supported duplexing size, for example A4 size, that can be printed by the imaging device 100, when the media duplexing apparatus 102 is not coupled to the imaging device. The media duplexing apparatus 102, referred to as apparatus 102 hereinafter, can be coupled to an imaging device 100 to scale up the capability of the imaging device 100 to duplex print a medium of a size larger than the threshold size. A medium of a size larger than the threshold size may be of A3 size.

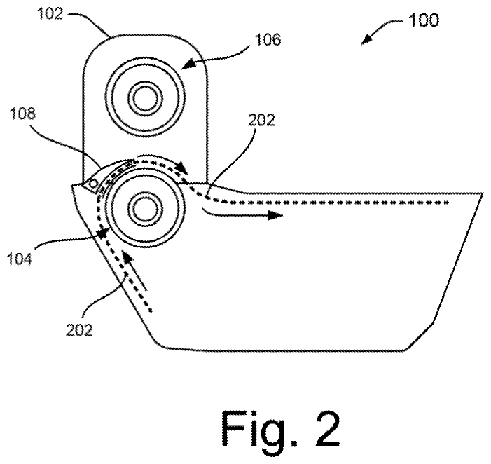

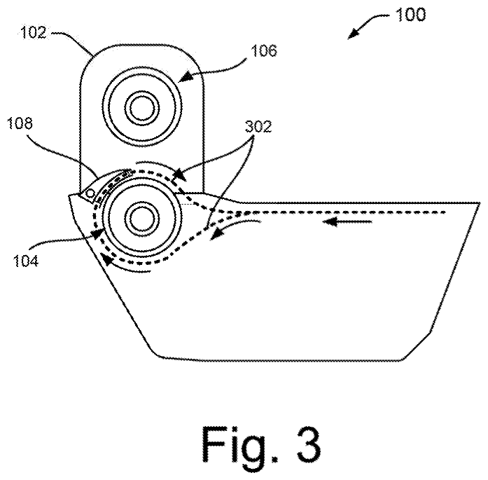

The imaging device 100, apart from other components, may include a first media roller assembly 104. The first media roller assembly 104 may refer to an internal media roller assembly of the imaging device 100, which is utilized for printing of a medium of a threshold size (or smaller), for example, A4 size. The first media roller assembly 104 may roll and advance a medium through a first path for duplex printing of the medium. An example first path is illustrated and described through FIGS. 2 and 3. The other components (not shown) of the imaging device 100 may include, but are not limited to, a printing unit, a media source, an input/output interface, and other electronic and electrical components.

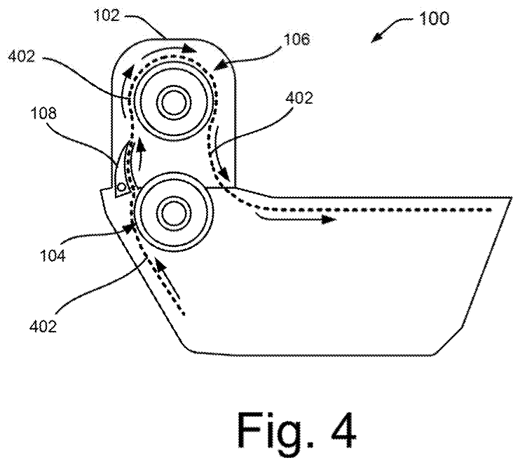

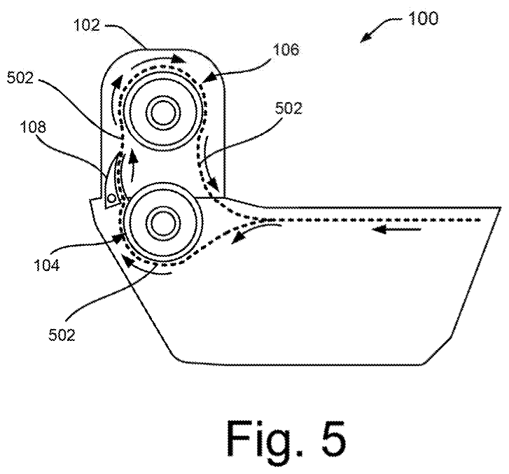

The apparatus 102 may include a media roller assembly 106 and a media diverter 108. The media roller assembly 106 of the apparatus 102 may hereinafter be referred to as a second media roller assembly 106. The second media roller assembly 106 may roll and advance a medium through a second path for duplex printing of the medium. An example second path is illustrated and described through FIGS. 4 and 5.

In an example, a media diverter may be an element movable between positions to route a medium through different paths for printing in an imaging device. In some examples, a media diverter may have a substantially oblong or flange like element to contact and divert media. In the example of FIG. 1, the media diverter 108 may be a flange like element which may be movable, in a direction 110, to a first position or a second position to route a medium through different paths for printing in the imaging device, depending on the size of the medium.

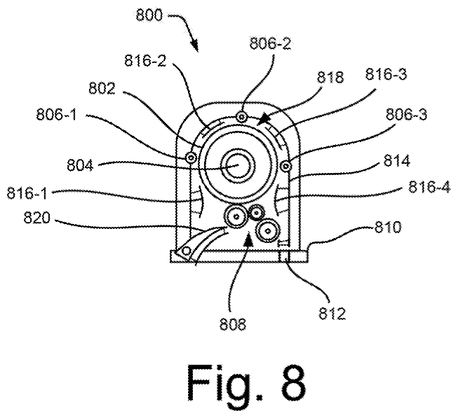

In an example, when a medium of a size equal to or smaller than the threshold size is to be duplex printed, the media diverter 108 may be movable to the first position to route the medium over the first path through the first media roller assembly 104. An example first position of the media diverter 108 is illustrated by position A in FIG. 1. Further, when a medium of a size larger than the threshold size is to be duplex printed, the media diverter 104 may be movable to the second position to route the medium over the second path through the second media roller assembly 106. An example second position of the media diverter 108 is illustrated by position B in FIG. 1. A medium may be routed through a media roller assembly by a roller assembly of the media roller assembly. Examples of roller assemblies of a media roller assembly are described with reference to FIG. 8.

In an example, the media diverter 108 may be rotatable about an axis parallel to a base plane of the apparatus 102. In the first position, the media diverter 108 may be at angle in a range of approximately 50° to 60° with respect to the base plane of the apparatus 102. In the second position, the media diverter 108 may be at angle in a range of approximately 80° to 90° with respect to the base plane of the apparatus 102.

In an example, the imaging device 100 may include a motor (not shown in FIG. 1) coupled to the first media roller assembly 104. The motor is coupled to drive the first media roller assembly 104 for rolling and advancing a medium through the first media roller assembly 104.

The imaging device 100 may include a gear assembly (not shown in FIG. 1). The gear assembly may be to couple the first media roller assembly 104 with the second media roller assembly 106, such that the first media roller assembly 104 may drive the second media roller assembly 106 through the gear assembly. An example of gear assembly is illustrated and described with reference to FIG. 8.

In another example, the apparatus 102 may include a motor (not shown in FIG. 1) coupled to the second media roller assembly 106. The motor may drive the second media roller assembly 106 for advancing a medium through the apparatus 102. The motor coupled to the second media roller assembly 106 and the motor coupled to the first media roller assembly 104, respectively, may operate to drive the media roller assemblies 106 and 104 in a synchronized manner.

Further, in an example, the imaging device 100 may include a media identifying engine (not shown in FIG. 1). The media identifying engine may determine a size of a medium to be printed by the imaging device 100. The media identifying engine may also determine whether the medium is to be duplex printed. Further, in an example, the imaging device 100 may include an actuator (not shown in FIG. 1) coupled to the media identifying engine and the media diverter 108. The actuator may actuate the media diverter 108 to move either to the first position or the second position. The media identifying engine may operate the actuator to actuate the media diverter 108 to the first position or the second position depending on the determination of the size of the medium to be printed and whether the medium is to be duplex printed. In an example, the actuator may be a linear actuator which may be coupled to the media diverter 108 through a gear to rotate the media diverter 108. In another example, the actuator may be a motor coupled to the media diverter 108 to rotate the media diverter 108.

The media identifying engine can be implemented through a combination of any suitable hardware and computer-readable instructions. The media identifying engine may be implemented in a number of different ways to perform various functions for determining the size of a medium to be printed and also determining whether the medium is to be duplex printed. For example, the computer-readable instructions for the media identifying engine may be processor-executable instructions stored in a non-transitory computer-readable storage medium, and the hardware for the media identifying engine may include a processing resource (e.g., processor(s)), to execute such instructions. In the present examples, the non-transitory computer-readable storage medium stores instructions which, when executed by the processing resource, implements the media identifying engine. The imaging device 100 may include the non-transitory computer-readable storage medium storing the instructions and the processing resource (not shown) to execute the instructions. In an example, the non-transitory computer-readable storage medium storing the instructions may be external, but accessible to the processing resource of the imaging device 100. In another example, the media identifying engine may be implemented by electronic circuitry.

The processing resource of the imaging device 100 may be implemented as microprocessors, microcomputers, microcontrollers, digital signal processors, central processing units, state machines, logic circuitries, and/or any devices that manipulate signals based on operational instructions. Among other capabilities, the processing resource may fetch and execute computer-readable instructions stored in a non-transitory computer-readable storage medium coupled to the processing resource of the imaging device 100. The non-transitory computer-readable storage medium may include, for example, a volatile memory (e.g., a random-access memory), and/or a non-volatile memory (e.g., an erasable programmable read-only memory, a flash memory, a non-volatile random-access memory, memristor, etc.).

The description hereafter describes the operation of the imaging device 100 and the apparatus 102 with reference to FIGS. 2 to 5 for duplex printing a medium depending on the size of the medium. For the purpose of description herein, an example case is presented in which the imaging device 100, without the apparatus 102, is capable of duplex printing of media of A4 size or smaller. The apparatus 102 may be coupled to the imaging device 100 to enable duplex printing of media of A3 size.

In an example, when the media identifying engine determines that a medium of A4 size or of a smaller size is to be duplex printed, the media identifying engine may operate the actuator to actuate the media diverter 108 to the first position. FIG. 2 illustrates a path 202 followed by the medium for printing on a first side of the medium, when the media diverter 108 is in the first position, according to an example. FIG. 3 illustrates a path 302 followed by the medium for printing on a second side of the medium, when the media diverter 108 is in the first position, according to an example. As illustrated in FIG. 2, for printing on the first side, the media diverter 108 may receive the medium from a media source (not shown in FIG. 1) of the imaging device 100. The media diverter 108, in the first position, may route the medium over the path 202 through the first media roller assembly 104, for example, towards a printing unit (not shown) of the imaging device 100. For printing on the second side, the medium may be moved from a position underneath the printing unit towards the first media roller assembly 104 over the path 302, as shown in FIG. 3. The media diverter 108 may receive the medium again and route the medium through the first media roller assembly 104 towards the printing unit. By passing through the first media roller assembly 104, the medium may turn-over to make the second side of the medium available for printing by the printing unit. After printing on the second side, the medium may be dispensed out by the imaging device 100. The paths 202 and 302 in combination may form the first path for duplex printing.

In an example, when the media identifying engine determines that a medium larger than the threshold size (e.g., A3 size) is to be duplex printed, the media identifying engine may operate the actuator to actuate the media diverter 108 to the second position. FIG. 4 illustrates a path 402 followed by the medium for printing on a first side of the medium, when the media diverter 108 is in the second position, according to an example. FIG. 5 illustrates a path 502 followed by the medium for printing on a second side of the medium, when the media diverter 108 is in the second position, according to an example. As illustrated in FIG. 4, for printing on the first side, the media diverter 108 may receive the medium from the media source of the imaging device 100. The media diverter 108, in the second position, may route the medium over the path 402 through the second media roller assembly 106, for example, towards the printing unit of the imaging device 100. For printing on the second side, the medium may be moved from a position underneath the printing unit towards the first media roller assembly 104 over the path 502, as shown in FIG. 5. The media diverter 108 may receive the medium again and route the medium through the second media roller assembly 106 towards the printing unit. By passing through the second media roller assembly 106, the medium may turn-over such that the second side of the medium is available for printing by the printing unit. After printing on the second side, the medium may be dispensed out by the imaging device 100. The paths 402 and 502 in combination may form the second path for duplex printing.

In an example, when the media identifying engine determines that a medium is to be single side printed, irrespective of the size of the medium, the media identifying engine may operate the actuator to actuate the media diverter 108 to the first position. For printing on one side of the medium, the media diverter 108 may receive the medium from the media source of the imaging device 100. The media diverter 108, in the first position, may route the medium through the first media roller assembly 104 towards the printing unit of the imaging device 100. After printing on the medium, the medium may be dispensed out by the imaging device 100.

Further, in an example, when the media identifying engine determines that a medium of A3 size is to be duplex printed, the media identifying engine may operate the actuator to move the media diverter 108 to the first position for printing a first side of the medium, and the media identifying engine may operate the actuator to move the media diverter 108 to the second position for printing a second side of the medium. In such a case, the media identifying engine may determine whether the first side of medium has been printed or not. After determining that the first side of the medium has been printed, the media identifying engine may operate the actuator to move the media diverter 108 from the first position to the second position. For printing on the first side, the media diverter 108 may receive the medium from the media source of the imaging device 100. The media diverter 108, in the first position, may route the medium through the first media roller assembly 104 towards the printing unit of the imaging device 100. For printing on the second side, the medium may be moved from a position underneath the printing unit towards the first media roller assembly 104. The media diverter 108, now in the second position, may receive the medium and route the medium through the second media roller assembly 106 towards the printing unit of the imaging device 100. After printing on the second side, the medium may be dispensed out by the imaging device 100.

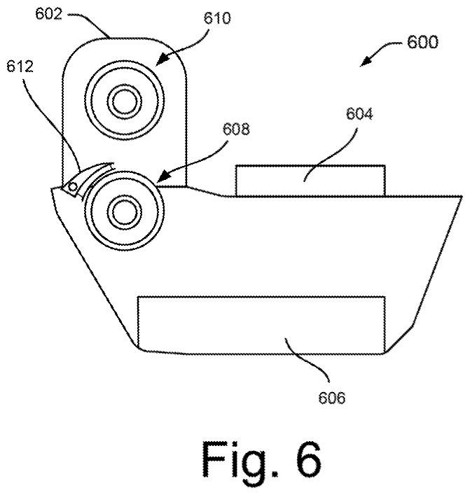

FIG. 6 illustrates a side view of an imaging device 600 with a media duplexing apparatus 602, according to an example. The imaging device 600, apart from other components, may include a printing unit 604, a first media source 606, and a first media roller assembly 608. The first media roller assembly 608 may be similar to the first media roller assembly 104 of the imaging device 100, which provides a first path for duplex printing. The printing unit 604 may print markings, such as text and images, on a medium. The printing unit 604 may include a printing fluid reservoir, a printing fluid pumping unit, and a print head. The first media source 606 may hold and supply media, for example, papers, for printing in the imaging device 600. The first media source 606 may be a tray or a bucket. The other components (not shown) of the imaging device 600 may include, but are not limited to, an input/output interface, and other electronic and electrical components.

The media duplexing apparatus 602 may be similar to the media duplexing apparatus 102 of the imaging device 100. The media duplexing apparatus 602, referred to as the apparatus 602 hereinafter, may be coupled to the imaging device 600 to scale up the capability of the imaging device 600 to duplex print a medium a size larger than a threshold size.

The apparatus 602 may include a second media roller assembly 610 and a media diverter 612. The second media roller assembly 610 and the media diverter 612 may be similar to the second media roller assembly 106 and the media diverter 108, respectively, as described earlier with reference to FIG. 1. As described earlier with respect to FIG. 1, the media diverter 612 may be movable to a first position to receive a medium from the first media source 606 and route the medium through the first media roller assembly 608 towards the printing unit 604, when the medium of a size equal to or smaller than a threshold size is being printed in the imaging device 600. The media diverter 612 may be movable to a second position to receive a medium from the first media source 606 and route the medium through the second media roller assembly 610 towards the printing unit 604, when the medium of a size larger than the threshold size is being duplex printed in the imaging device 600. In an example, the imaging device 600 may include a media identifying engine and an actuator similar to as described with reference to FIG. 1. The operation of the imaging device 600 and different paths followed by media of different sizes for duplex printing in the imaging device 600 may be similar to as described through FIGS. 2 to 5.

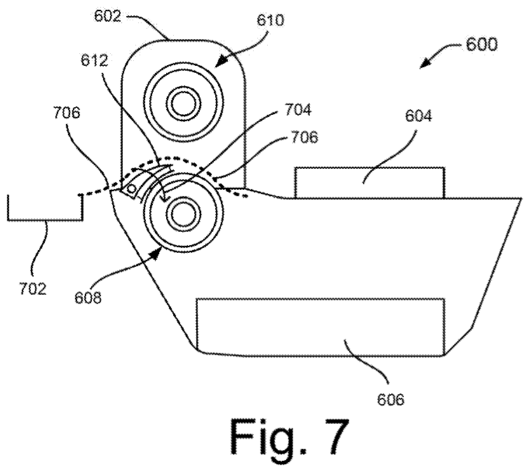

In an example, the media diverter 612 in the apparatus 602 may be movable downwards upon application of gravitational force on the media diverter 612. FIG. 7 illustrates the imaging device 600 with the media diverter 612 positioned to route a medium from a second media source 702 towards the printing unit 604 of the imaging device 600, according to an example. The second media source may be a media source external to the imaging device 600, or a media source internal to the imaging device 600, but different from the first media source 606. The second media source 702 may hold and supply media, for example, papers, for printing in the imaging device 600. The second media source 702 may be a tray or a bucket.

As illustrated in FIG. 7, the imaging device 600 may receive a medium from the second media source 702. The medium, upon being received in the imaging device 600, may push the media diverter 612 in a direction 704. The medium may accordingly move towards the printing unit 604. A path followed by the medium is referenced as 706. Once the medium has passed the media diverter 612, the media diverter 104 may move back in a direction opposite to the direction 704 to its original position.

FIG. 8 illustrates a cross-sectional side view of a media duplexing apparatus 800, according to an example. The media duplexing apparatus 800, referred to as apparatus 800 hereinafter, may include a media roller assembly 818 and a media diverter 820 similar to the second media roller assembly 106 and the media diverter 108 of the media duplexing apparatus 102. The media roller assembly 818 may include a driver roller assembly (e.g., comprising driver roller 802) and a pinch roller assembly (e.g., comprising pinch rollers 806-1, 806-2, and 806-3). The driver roller assembly may roll a medium to switch the side of the medium available for printing in the imaging device. The pinch roller assembly may grip a medium being rolled over the driver roller assembly. The driver roller assembly and the pinch roller assembly may facilitate advancing a medium through the apparatus 800.

The driver roller assembly may include an array of driver rollers. One driver roller 802 is visible in the cross-sectional side view of the apparatus 800 shown in FIG. 8. The array of driver rollers of the driver roller assembly may be fixedly coupled to a shaft 804, such that a rotation of the shaft 804 rotates the driver rollers. The pinch roller assembly may include an array of pinch rollers at positions corresponding to the positions of the driver rollers of the driver roller assembly. In an example, a pinch roller may be a star wheel. The pinch roller assembly may be such that a plurality of pinch rollers is positioned around each driver roller of the driver roller assembly. In an example, as shown in FIG. 8, three pinch rollers 806-1, 806-2, 806-3 may be positioned around the driver roller 802. The pinch rollers may grip and roll the medium over the driver rollers to advance the medium through the apparatus 800.

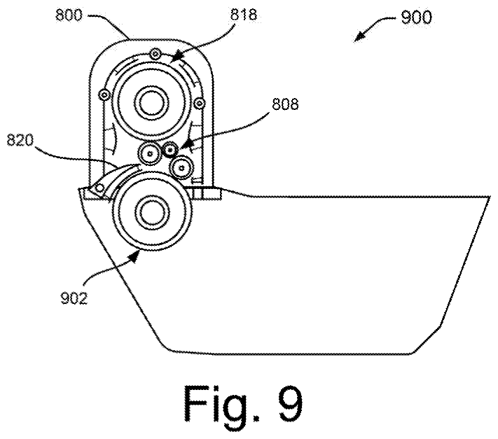

The apparatus 800 may include a gear assembly 808 coupled to the media roller assembly 818. In an example, the gear assembly 808 may include an array of gears. A gear at one side of the array of gears may be coupled to the shaft 804 of the driver roller assembly. The gear assembly 808 can be coupled to an internal media roller assembly of an imaging device through a gear at the other side of the array of gears. The gear assembly 808 may be coupled to the internal media roller assembly of the imaging device to drive the media roller assembly 818 for advancing a medium through the apparatus 800. FIG. 9 illustrates a side view of an imaging device 900 with the media duplexing apparatus 800, according to an example. As shown in FIG. 9, the gear assembly 808 of the apparatus 800 is coupled to an internal media roller assembly 902 of the imaging device 900. The internal media roller assembly 902 of the imaging device 900 may be similar to the first media roller assembly 104 of the imaging device 100. In another example, the apparatus 800 may include a motor (not shown) coupled to the media roller assembly 818. The motor is coupled to drive the media roller assembly 818 for advancing a medium through the apparatus 800.

Returning to FIG. 8, in an example, the apparatus 800 may include an actuator (not shown in FIG. 8) coupled to the media diverter 820. The actuator may actuate the media diverter 820 to the first position, when printing a medium of a size equal to or smaller than a threshold size, for example, A4 size. The actuator may also actuate the media diverter 820 to the second position, when printing a medium of a size larger than the threshold size, for example, A3 size. In an example, the actuator may be a linear actuator which may be coupled to the media diverter 820 through a gear to rotate the media diverter 820. In another example, the actuator may be a motor coupled to the media diverter 820 to rotate the media diverter 820.

The apparatus 800 may also include a base plate 810 with a slot 812. A medium which may be routed through the media roller assembly 818 may pass through the slot 812 and further move towards a printing unit of the imaging device for printing. The base plate 810 may also have an opening through which the gear assembly 808 can be coupled to an internal media roller assembly of an imaging device for driving the media roller assembly 818.

The apparatus 800 may further include a media guide 814. The media guide 814 may guide a medium through the media roller assembly 106. The media guide 814 may have guide elements 816-1, 818-2, 816-3, 816-4 to guide a medium from an output end of the media diverter 108, when in the second position, through the media roller assembly 106 and the slot 812 in the base plate 810.

In an example, the base plate 810 of the apparatus 800 may be formed as a cleanout tray of an imaging device. The cleanout tray of an imaging device may be a removable tray, which can be removed for cleaning the internal media roller assembly and other components of the imaging device. Forming the base plate 810 of the apparatus 800 similar to the cleanout tray of an imaging device may facilitate easy and quick coupling of the apparatus 800 to the imaging device. The cleanout tray of the imaging device may be removed and the apparatus 800 may be coupled to the imaging device by attaching the base plate 810 to the imaging device.

Similar to as described earlier for the media roller assembly 818 of the media duplexing apparatus 800, in an example, the internal media roller assembly 902 of the imaging device 900, or the first media roller assembly 104 of the imaging device 100, may also include a driver roller assembly and a pinch roller assembly. The driver roller assembly of the internal media roller assembly 902 may include an array of driver rollers. The array of driver rollers of the driver roller assembly may be fixedly coupled to a shaft. A rotation of the shaft rotates the driver rollers. The pinch roller assembly of the internal media roller assembly 902 may include an array of pinch rollers at positions corresponding to the positions of the driver rollers of the driver roller assembly. In an example, a pinch roller may be a star wheel. The pinch roller assembly may be such that a plurality of pinch rollers is positioned around each driver roller of the driver roller assembly. The pinch rollers may grip and roll the medium over the driver rollers to advance the medium through the internal media roller assembly 902.

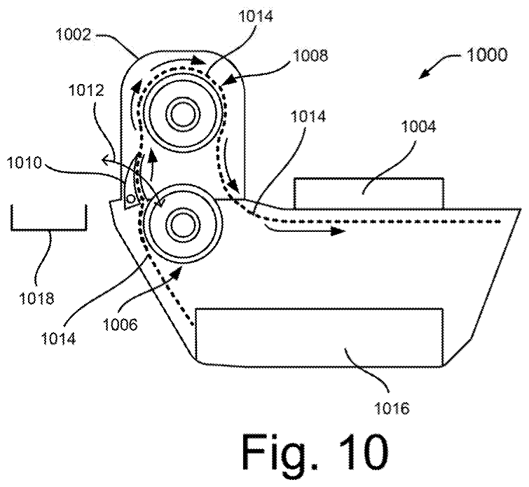

FIG. 10 illustrates a side view of an imaging device 1000 with a media duplexing apparatus 1002, according to an example. The imaging device 1000, apart from other components, may include a printing unit 1004, afirst media source 1016, and a first media roller assembly 1006. The printing unit 1004 may be similar to the printing unit 604 of the imaging device 600 and may include a printing fluid reservoir, a printing fluid pumping unit, and a print head. The first media source 1016 may be a media tray or a bucket to hold and supply media, for example, papers, for printing by the imaging device 1000. The first media roller assembly 1006 may refer to an internal media roller assembly of the imaging device 1000, which may be utilized for printing of a medium of a threshold size, for example, A4 size, in the absence of the media duplexing apparatus 1002. In an example, the first media roller assembly 1006 may be similar to the first media roller assembly 104 as described with reference to FIG. 1. In an example, the imaging device 1000 may include a motor (not shown) coupled to the first media roller assembly 1006. The motor is coupled to drive the first media roller assembly 1006 for advancing a medium through the first media roller assembly 1006. The other components (not shown) of the imaging device 1000 may include, but are not limited to, an input/output interface, and other electronic and electrical components.

The media duplexing apparatus 1002, referred to as apparatus 1002 hereinafter, may include a second media roller assembly 1008 and the media diverter 1010. The second media roller assembly 1008 and the media diverter 1010 may similar to the second media roller assembly 106 and the media diverter 108, respectively, as described with reference to FIG. 1.

The imaging device 1000 may include a gear assembly (not shown in FIG. 10) coupled to the second media roller assembly 1008. The gear assembly may be similar to the gear assembly 808 described with reference to FIG. 8. The gear assembly may be coupled to the first media roller assembly 1006 to drive the second media roller assembly 1008 for advancing a medium through the apparatus 1002.

In another example, the apparatus 1002 may include a motor (not shown in FIG. 10) coupled to the second media roller assembly 1008. The motor is coupled to drive the second media roller assembly 1008 for advancing a medium through the apparatus 1002. The motor coupled to the second media roller assembly 1008 and the motor coupled to the first media roller assembly 1006, respectively, may operate to drive the assemblies 1008 and 1006 in a synchronized manner.

In an example, the media diverter 1010 may be movable in a direction 1012 between a first position and a second position. In the first position, the media diverter 1010 may receive a medium from the first media source 1016 over the first media roller assembly 1006 and route the medium through the second media roller assembly 1008 towards the printing unit 1004. FIG. 10 shows the media diverter 1010 in the first position. FIG. 10 also shows a path 1014 followed by a medium, when the media diverter 1010 is in the first position.

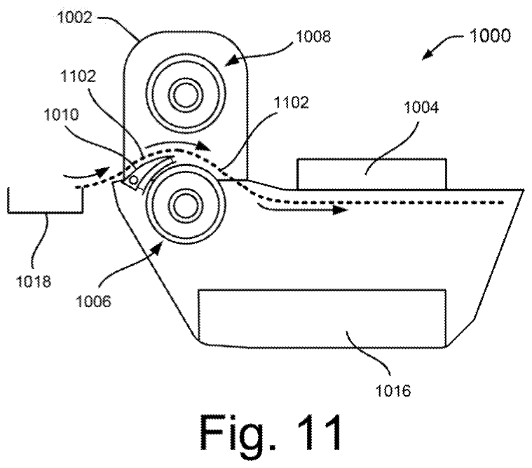

In the second position, the media diverter 1010 may route a medium from a second media source 1018 towards the printing unit 1004, bypassing the first media roller assembly 1006 and the second media roller assembly 1008. The second media source 1018 may be a media source external to the imaging device 1000, or a media source internal to the imaging device 1000, but other than the first media source 1016. FIG. 11 illustrates the imaging device 1000, according to an example, in which the media diverter 1010 is in the second position. As illustrated in FIG. 11, the imaging device 1000 may receive a medium from the second media source 1018. The medium, upon being received in the imaging device 1000, may push the media diverter 1010 downward. The medium then moves towards the printing unit 1004 for printing. A path followed by the medium towards the printing unit 1004 is referenced as 1102. Once the medium has passed the media diverter 1010, the media diverter 1010 may move back to the first position.

In an example, when a medium from the first media source 1016 of the imaging device 1000 is to be printed in the imaging device 900, irrespective of the size of the medium and whether a single side or both sides of the medium are to be printed, the media diverter 1010 may be in the first position. In operation, a medium may be picked up from the first media source 1016 and passed towards the first media roller assembly 1006. The media diverter 1010, in the first position, may receive the medium from the first media roller assembly 1006 and route the medium through the second media roller assembly 1008 towards the printing unit 1004. In case of a single side printing, the medium after printing may be dispensed from the imaging device 1000. In case of duplex printing, the medium may be moved back towards the first media roller assembly 1006. The media diverter 1010 may receive the medium again from the first media roller assembly 1006 and route through the second media roller assembly 1008 towards the printing unit 1004 for printing on a second side of the medium.

In case the medium from the second media source 1018 is to be duplex printed, the medium may be moved from a position underneath the printing unit 1004 towards the first media roller assembly 1006. The media diverter 1010, now in the first position, may receive the medium and route the medium through the second media roller assembly 1008 towards the printing unit 1004 for printing on the second side of the medium. After printing on the second side, the medium may be dispensed out by the imaging device 1000.

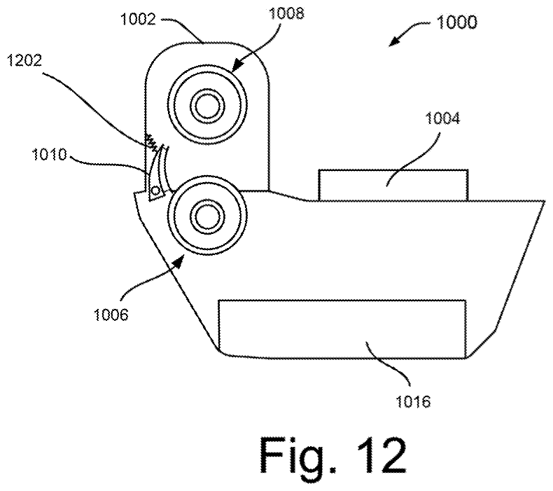

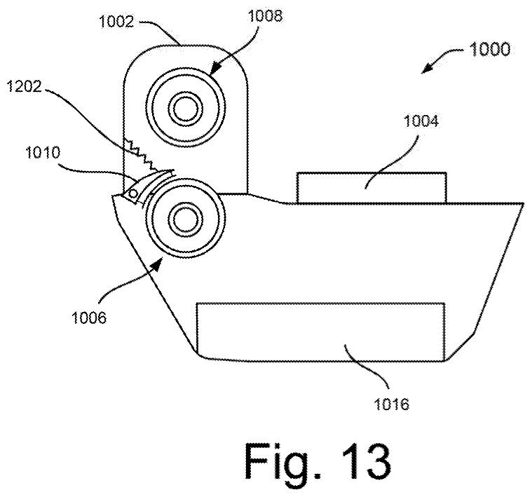

In an example, the media duplexing apparatus may include a biasing element coupled to the media diverter. The biasing element may retain the media diverter in the first position. FIG. 12 illustrates a side view of the imaging device 1000 with a biasing element 1202 coupled to the media diverter 1010, according to an example. The biasing element 1202 may include a spring. The biasing element 1202 in its unbiased state may retain the media diverter 1010 in the first position as shown in FIG. 12. Thus, the first position of the media diverter 1010 may be a default position. When a medium is received from the second media source 1018, the medium may push the media diverter 1010 downward and bias the biasing element 1202. FIG. 13 illustrates the imaging device 1000 with the biasing element 1202 in a biased state, according to an example. Once the medium has passed the media diverter 1010, the biasing element may release which may move the media diverter 1010 back to the first position.

Although examples for the present disclosure have been described in language specific to structural features, it is to be understood that the appended claims are not limited to the specific features described herein. Rather, the specific features are disclosed and explained as examples of the present disclosure.

We claim:

1. An imaging device comprising:
a first media roller assembly to provide a first path for duplex printing; and
a media duplexing apparatus to provide a second path for duplex printing, the second path being longer than the first path, the media duplexing apparatus including:
a second media roller assembly; and
a media diverter, the media diverter being movable to:
a first position to route a medium over the first path through the first media roller assembly, when the medium of a size equal to or smaller than a threshold size is being duplex printed; and
a second position to route a medium over the second path through the second media roller assembly, when the medium of a size larger than the threshold size is being duplex printed.

2. The imaging device as claimed in claim 1, further comprising a media identifying engine to:
determine a size of the medium to be printed; and
determine whether the medium is to be duplex printed.

3. The imaging device as claimed in claim 2, further comprising an actuator coupled to the media identifying engine and the media diverter, wherein the media identifying engine is to operate the actuator to:
actuate the media diverter to the first position, when the medium of the size equal to or smaller than the threshold size is determined for being printed; and
actuate the media diverter to the second position, when the medium of the size larger than the threshold size is determined for being the duplex printed.

4. The imaging device as claimed in claim 3, wherein the media identifying engine is to operate the actuator to:
move the media diverter to the first position, when printing a first side of the medium of the size larger than the threshold size; and
move the media diverter to the second position, when printing a second side of the medium of the size larger than the threshold size.

5. The imaging device as claimed in claim 1, further comprising a gear assembly to couple the first media roller assembly with the second media roller assembly, wherein the first media roller assembly is to drive the second media roller assembly through the gear assembly.

6. The imaging device as claimed in claim 1, wherein the media duplexing apparatus further comprises a motor coupled to the second media roller assembly to drive the second media roller assembly.

7. An imaging device comprising:
a printing unit;
a first media source;
a first media roller assembly; and
a media duplexing apparatus including:
a second media roller assembly; and
a media diverter, the media diverter being movable to:
a first position to receive a medium from the first media source and route the medium through the first media roller assembly towards the printing unit, when the medium of a size equal to or smaller than a threshold size is being printed; and
a second position to receive a medium from the first media source and route the medium through the second media roller assembly, when the medium of a size larger than the threshold size is being duplex printed.

8. The imaging device as claimed in claim 7, wherein the media diverter is movable to the first position to route a medium from a second media source towards the printing unit.

9. The imaging device as claimed in claim 7, further comprising a media identifying engine to:
determine a size of the medium to be printed; and
determine whether the medium is to be duplex printed.

10. The imaging device as claimed in claim 9, further comprising an actuator coupled to the media identifying engine and the media diverter, wherein the media identifying engine is to operate the actuator to:
actuate the media diverter to the first position when the medium of the size equal to or smaller than the threshold size is determined for being printed; and
actuate the media diverter to the second position when the medium of the size larger than the threshold size is determined for being the duplex printed.

11. The imaging device as claimed in claim 10, wherein the media identifying engine is to operate the actuator to:
move the media diverter to the first position, when printing a first side of the medium of the size larger than the threshold size; and
move the media diverter to the second position, when printing a second side of the medium of the size larger than the threshold size.

12. An imaging device comprising:
a printing unit;
a first media source;
a first media roller assembly; and
a media duplexing apparatus including:
a second media roller assembly; and
a media diverter, wherein the media diverter,
in a first position, is to receive a medium from the first media source over the first media roller assembly and route the medium through the second media roller assembly towards the printing unit, and
in a second position, is to route a medium from a second media source towards the printing unit, bypassing the first media roller assembly and the second media roller assembly.

13. The imaging device as claimed in claim 12, wherein the media duplexing apparatus further comprises a biasing element coupled to the media diverter, wherein the biasing element is to retain the media diverter in the first position.

14. The imaging device as claimed in claim 12, further comprising a gear assembly to couple the first media roller assembly with the second media roller assembly, the first media roller assembly is to drive the second media roller assembly through the gear assembly.

15. The imaging device as claimed in claim 12, wherein the media duplexing apparatus further comprises a motor coupled to the second media roller assembly to drive the second media roller assembly.
